(19) United States
(12) Patent Application Publication
(10) Pub. No.: US 2026/0175495 A1
(43) Pub. Date: Jun. 25, 2026

(54) INJECTION MOLDING SYSTEM, CONTROL DEVICE, INJECTION MOLDING METHOD, AND NON-TRANSITORY COMPUTER READABLE MEDIUM STORING PROGRAM

(71) Applicant: SUMITOMO HEAVY INDUSTRIES, LTD., Tokyo (JP)

(72) Inventors: Shintaroh SUGIMOTO, Yokosuka-shi (JP); Kana INOUE, Yokosuka-shi (JP)

(21) Appl. No.: 19/299,256

(22) Filed: Aug. 13, 2025

(30) Foreign Application Priority Data
Dec. 25, 2024 (JP) 2024-229252

(51) Int. Cl. B29C 45/76; B29C 45/00

(52) U.S. Cl. CPC B29C 45/76; B29C 2045/0096; B29C 2945/76287; B29C 2945/76347; B29C 2945/76461; B29C 2945/76802

(57) ABSTRACT

An injection molding system includes: a material imaging unit that images a material before being input from a material dryer that performs pre-drying of the material for injection molding to an injection molding machine; a material state acquisition unit that acquires a measurement result of a state of the material based on a captured image of the imaged material; and a process control unit that controls one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

### CROSS-REFERENCE TO RELATED APPLICATIONS

This application claims priority to Japanese Patent Application No. 2024-229252, filed on December 25, 2024, which is incorporated by reference herein in its entirety.

### BACKGROUND

### Technical Field

Certain embodiments of the present invention relate to an injection molding system, a control device, an injection molding method, and a non-transitory computer readable medium storing a non-transitory computer readable medium storing a program.

### Description of Related Art

A technique in which a state of an injection molding machine during molding or a state of a molding product is acquired and reflected on molding conditions is known (for example, the related art).

### SUMMARY

According to an embodiment of the present invention, there is provided an injection molding system including: a material imaging unit that images a material before being input from a material dryer that performs pre-drying of the material for injection molding to an injection molding machine; a material state acquisition unit that acquires a measurement result of a state of the material based on a captured image of the imaged material; and a process control unit that controls one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

Here, the process control unit may control a process of giving a notification of a possibility of causing a molding defect as the process of giving a notification of the measurement result of the state of the material.

In addition, the process control unit may control a process of returning the material to the material dryer to dry the material again as the process of reviewing the material itself.

In addition, the process control unit may control a process of making a change into a drying condition corresponding to the measurement result of the state of the material as the process of reviewing the drying condition.

In addition, the process control unit may control a process of making a change into the drying condition further corresponding to information on a lot of the material.

In addition, the process control unit may control a process of making a change into the molding condition corresponding to the measurement result of the state of the material as the process of reviewing the molding condition.

In addition, the process control unit may control a process of making a change into the molding condition further corresponding to the information on the lot of the material.

In addition, the process control unit may control a process of making a change into a cylinder inner temperature as the molding conditions further corresponding to the information on the lot of the material.

In addition, the material state acquisition unit may acquire an amount of moisture contained in the material as the measurement result of the state of the material, and the process control unit may control a process for suppressing a molding defect in correspondence with the amount of moisture.

In addition, the material state acquisition unit may acquire information indicating each of states of a resin and an additive contained in the material as the measurement result of the state of the material.

In addition, the material state acquisition unit may acquire information indicating a mixed state of a plurality of types of resins contained in the material as the measurement result of the state of the material.

According to another embodiment of the present invention, there is provided an injection molding system including: a material imaging unit that images a material before being input from a material dryer that performs pre-drying of the material for injection molding to an injection molding machine; a material state acquisition unit that acquires a measurement result of a state of the material based on a captured image of the imaged material; and a process control unit that controls one or more processes among a process of giving a notification of a measurement result of a state of a molding product, a process of reviewing the material itself for injection molding, a process of reviewing a drying condition of the material dryer, and a process of reviewing a molding condition of the injection molding machine in correspondence with the acquired measurement result of the state of the material.

Here, the process control unit may control a process of returning the material to the material dryer to dry the material again as the process of reviewing the material itself.

In addition, the process control unit may control a process of making a change into a drying condition corresponding to the measurement result of the state of the molding product as the process of reviewing the drying condition.

In addition, the process control unit may control a process of making a change into the drying condition further corresponding to information on a lot of the material.

According to still another embodiment of the present invention, there is provided a control device including: a material imaging unit that images a material before being input from a material dryer that performs pre-drying of the material for injection molding to an injection molding machine; a material state acquisition unit that acquires a measurement result of a state of the material based on a captured image of the imaged material; and a process control unit that controls one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

According to still another embodiment of the present invention, there is provided an injection molding method including: a step of imaging a material before being input from a material dryer that performs pre-drying of the material for injection molding to an injection molding machine; a step of acquiring a measurement result of a state of the material based on a captured image of the imaged material; and a step of controlling one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

According to still another embodiment of the present invention, there is provided a non-transitory computer readable medium storing a program when executed by a processor, causing the processor to: image a material before being input from a material dryer that performs pre-drying of the material for injection molding to an injection molding machine; acquire a measurement result of a state of the material based on a captured image of the imaged material; and control one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

In addition, an injection molding system of the present invention is an injection molding system including: a material imaging unit that images a material before being input from a material dryer that performs pre-drying of a material for injection molding to an injection molding machine; a material state acquisition unit that acquires a measurement result of a state of the material based on a captured image of the imaged material; and a process control unit that controls a process for suppressing a molding defect in correspondence with the acquired measurement result of the state of the material.

In addition, an injection molding system of the present invention is an injection molding system including: a molding product imaging unit that images a molding product after injection molding; a molding product state acquisition unit that acquires a measurement result of a state of the molding product based on a captured image of the imaged molding product; and a process control unit that controls a process for suppressing a molding defect in correspondence with the acquired measurement result of the state of the molding product.

### BRIEF DESCRIPTION OF THE DRAWINGS

FIG. 1 is a view illustrating an example of an overall configuration of an injection molding system to which the present embodiment is applied.

FIG. 2 is a view illustrating an example of a hardware configuration of a management server constituting the injection molding system in FIG. 1.

FIG. 3 is a view illustrating an example of a functional configuration of a control unit of the management server.

FIG. 4 is a flowchart illustrating an example of a flow of a process of the management server.

FIG. 5 is a view illustrating a specific example of a method in which a material camera that constitutes the injection molding system in FIG. 1 measures a state of a material by using a millimeter wave or a terahertz wave.

FIGS. 6A and 6B are views illustrating a specific example of a method in which a molding product camera that constitutes the injection molding system in FIG. 1 measures a state of a molding product by using a millimeter wave or a terahertz wave.

FIGS. 7A and 7B are views illustrating a specific example of a method in which a molding product camera that constitutes the injection molding system in FIG. 1 measures a state of a molding product by using a millimeter wave or a terahertz wave.

### DETAILED DESCRIPTION

However, a technique of acquiring information indicating a state of a material from a captured image of the material for injection molding and reflecting the information on drying conditions of a material dryer or on molding conditions of an injection molding machine is not known.

It is desirable to acquire information indicating a state of a material from a captured image of the material for injection molding to reflect the information on the drying conditions of the material dryer or on the molding conditions of the injection molding machine to suppress a molding defect.

### CONFIGURATION OF INJECTION MOLDING SYSTEM 1

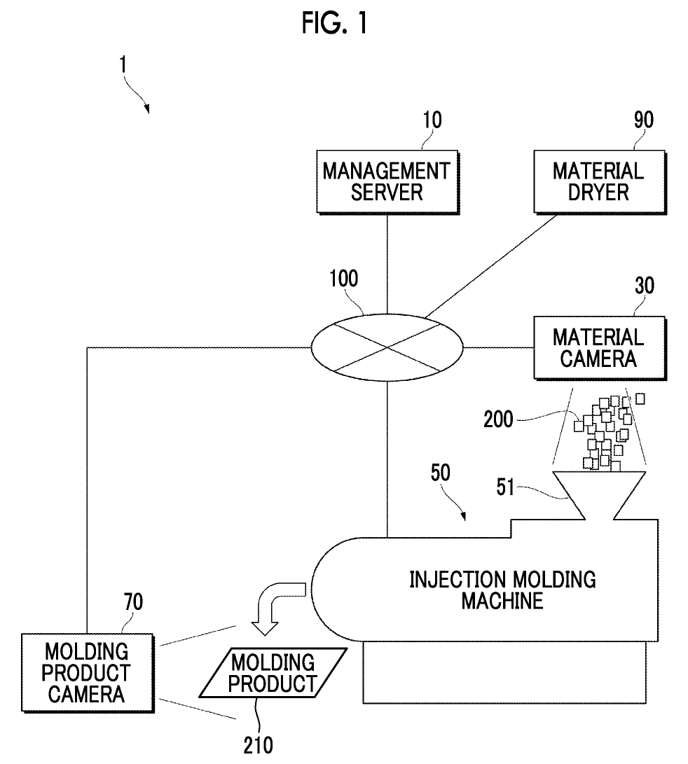

FIG. 1 is a view illustrating an example of an overall configuration of an injection molding system 1 to which the present embodiment is applied.

In the injection molding system 1, a management server 10 as a control device, a material camera 30 as material imaging means, an injection molding machine 50, a molding product camera 70 as molding product imaging means, and a material dryer 90 are connected to each other via a network 100. The network 100 is, for example, a local area network (LAN), the Internet, or the like.

### MANAGEMENT SERVER 10

The management server 10 that constitutes the injection molding system 1 is an information processing apparatus serving as a server that manages the entire injection molding system 1. The management server 10 makes it possible to execute application software that makes the injection molding system 1 usable. The management server 10 makes it possible to transmit various types of information to each of the injection molding machine 50, the material dryer 90, and the outside, and to execute various processes. In addition, the management server 10 makes it possible to acquire various types of information transmitted from each of the material camera 30, the injection molding machine 50, the molding product camera 70, the material dryer 90, and the outside, and to execute various processes.

For example, the management server 10 acquires log information of the injection molding machine 50. The log information of the injection molding machine 50 includes at least molding conditions of the injection molding machine 50. In addition, the management server 10 acquires a measurement result by the material camera 30 which indicates a state of a material 200 before being input from the material dryer 90 that performs pre-drying of the material 200 for injection molding to the injection molding machine 50. The measurement result by the material camera 30 is a measurement result of the state of the material 200 based on a captured image of the material 200 imaged by the material camera 30. In addition, the management server 10 acquires a measurement result by the molding product camera 70 which indicates a state of a molding product 210 after injection molding by the injection molding machine 50. The measurement result by the molding product camera 70 is a measurement result of a state of the molding product 210 based on a captured image of the molding product 210 imaged by the molding product camera 70.

In addition, the management server 10 manages the acquired log information of the injection molding machine 50, the measurement result of the material 200 measured by the material camera 30, and the measurement result of the molding product 210 measured by the molding product camera 70 in association with each other. In addition, the management server 10 makes it possible to perform a process corresponding to the measurement result of the material 200. For example, the management server 10 performs a process for suppressing a molding defect (hereinafter, referred to as "molding defect suppression process") as one of the processes corresponding to the measurement result of the material 200. For example, the molding defect suppression process includes a process of notifying a worker of the measurement result of the material 200, a process of reviewing the material 200 itself, a process of reviewing drying conditions of the material dryer 90, and a process of reviewing molding conditions of the injection molding machine 50.

That is, the management server 10 determines the drying conditions of the material dryer 90 and the molding conditions of the injection molding machine 50 which correspond to the measurement results of the state of the material 200. Then, the management server 10 makes it possible to perform a control of reflecting each of the determined drying conditions and molding conditions on each of the material dryer 90 and the injection molding machine 50.

In addition, the management server 10 makes it possible to perform a process corresponding to the measurement result of the state of the molding product 210. For example, the management server 10 controls the molding defect suppression process corresponding to the measurement result of the state of the molding product 210. The molding defect suppression process includes, for example, a process of notifying a worker of the measurement result of the state of the molding product 210, a process of reviewing the material 200 itself, a process of reviewing the drying conditions of the material dryer 90, and a process of reviewing the molding conditions of the injection molding machine 50.

That is, the management server 10 makes it possible to determine and update the drying conditions of the material dryer 90 and the molding conditions of the injection molding machine 50 which correspond to the measurement result of the state of the molding product 210.

Specifically, for example, the management server 10 determines each of the drying conditions of the material dryer 90 and the molding conditions of the injection molding machine 50 in correspondence with the amount of moisture contained in the material 200 which is acquired as the measurement result of the state of the material 200. The amount of moisture contained in the material 200 is measured, for example, based on light and shade of a color of two-dimensional information obtained from the captured image of the material 200. Then, each of the determined drying conditions and molding conditions is updated by reflecting each of the drying conditions and molding conditions on the material dryer 90 and the injection molding machine 50. In this case, the management server 10 makes it possible to cause the material dryer 90 to perform the pre-drying of the material 200 based on the drying conditions reflected on the material dryer 90. Details of the processes performed by the management server 10 will be described later.

### MATERIAL CAMERA 30

The material camera 30 that constitutes the injection molding system 1 is a camera that makes it possible to image the material 200 and to measure a state of the material 200 based on a captured image. The material camera 30 is constituted by various cameras such as a hyperspectral camera and a spectroscopic camera. The material camera 30 may generate an image of the material 200 by irradiating the material 200 with electromagnetic waves and receiving reflected waves from the material 200. In this case, since it is preferable that the reflected wave from the material 200 is large, the material camera 30 is preferably configured to be set with, for example, an electromagnetic wave irradiation device. When the material camera 30 measures the state of the material 200 based on the captured image of the material 200 before being input to the injection molding machine 50, the material camera 30 transmits the measurement result to the management server 10.

### INJECTION MOLDING MACHINE 50

The injection molding machine 50 that constitutes the injection molding system 1 is a molding machine that makes it possible to manufacture the molding product 210 by injection molding using a chip-shaped material 200 containing at least a resin. The injection molding machine 50 includes an injection unit that receives the material 200, heats and meters the material 200, and injects the material 200 toward a mold, and a mold that molds the molding product 210 by cooling and solidifying the injected material 200. The injection molding machine 50 is provided with an input port 51 for receiving the chip-shaped material 200.

### MOLDING PRODUCT CAMERA 70

The molding product camera 70 that constitutes the injection molding system 1 is a camera that makes it possible to image the molding product 210 output as a product from the injection molding machine 50, and to measure a state of the molding product 210 based on the captured image. The molding product camera 70 is constituted by various types of cameras such as a hyperspectral camera and a spectroscopic camera capable of imaging an external appearance. That is, the molding product camera 70 may be a camera having a special function such as a hyperspectral camera, for example, or may be a commonly available color camera or monochrome camera. In addition, in a case where the molding product camera 70 is used to measure a state of the material 200 by imaging using terahertz waves, it is preferable that the molding product camera 70 is configured as a set with an electromagnetic wave irradiation device. When the state of the molding product 210 is measured based on the captured image of the molding product 210, the molding product camera 70 transmits a measurement result to the management server 10.

### MATERIAL DRYER 90

The material dryer 90 that constitutes the injection molding system 1 is a device that performs pre-drying of the chip-shaped material 200 before being input to the injection molding machine 50. The material dryer 90 is connected to the injection molding machine 50 by a pipe (not illustrated) connecting the material dryer 90 to the input port 51 of the injection molding machine 50. For this reason, the material 200 that is input to the input port 51 of the injection molding machine 50 may be returned to the material dryer 90 via a pipe before being received by the injection unit. An operation of the material dryer 90 is controlled by the management server 10.

The above-described processes performed by each of the management server 10, the material camera 30, the injection molding machine 50, the molding product camera 70, and the material dryer 90 that constitute the injection molding system 1 are merely an example. In addition, the management server 10 may be a single personal computer, or may include a plurality of servers. In addition, a part of the system may be constructed on the cloud. Since the injection molding system 1 may be provided with a function of realizing the above-described processes as a whole system, some or all of the functions of realizing the above-described processes may be shared or may cooperate with each other in the injection molding system 1.

For example, some or all of the functions of the management server 10 may be used as functions of other devices (for example, the injection molding machine 50) in the injection molding system 1. In addition, some or all of the functions of the other devices in the injection molding system 1 may be set as functions of the management server 10. Further, some or all of the functions of the management server 10 may be transferred to another server (not illustrated). In this manner, the processes of the entire injection molding system 1 are promoted, and the processes can complement each other.

### HARDWARE CONFIGURATION OF MANAGEMENT SERVER 10

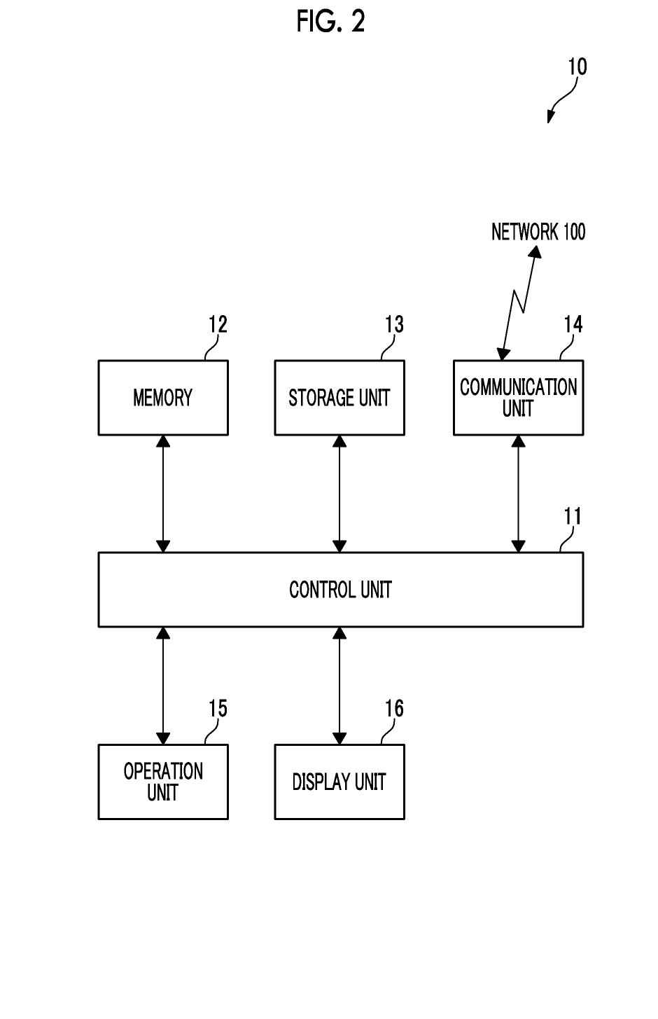

FIG. 2 is a view illustrating an example of a hardware configuration of the management server 10 constituting the injection molding system 1 of FIG. 1.

The management server 10 includes a control unit 11, a memory 12, a storage unit 13, a communication unit 14, an operation unit 15, and a display unit 16. Each of these units is connected by a data bus, an address bus, a peripheral component interconnect (PCI) bus, or the like.

The control unit 11 is a processor that controls the functions of the management server 10 through execution of various types of software such as an OS (basic software) and application software. In a case of the present embodiment, various processes are executed by an arbitrary computer. The arbitrary computer may be realized as a processor as hardware, a program as software, or a combination thereof. The arbitrary computer may be a general-purpose computer, a computer for a specific application, a workstation, or other systems capable of executing various processes.

The processor is configured to execute various processes in cooperation with a program. The processor may function as each unit or each means in the present embodiment. An execution order of the processes by the processor is not limited to the order described in the present embodiment, and can be changed as necessary.

The processor can be constituted by one or a plurality of pieces of hardware. A type of hardware constituting the processor is not limited to a specific type. For example, the processor may be a central processing unit (CPU), a micro processing unit (MPU), a programmable logic device such as a field-programmable gate array (FPGA), a dedicated circuit for executing a specific process such as an application-specific integrated circuit (ASIC), a graphics processing unit (GPU), or hardware such as a neural processing unit (NPU).

The processor is not limited to a combination of a plurality of pieces of hardware of the same type, and can also be constituted by a combination of a plurality of pieces of hardware of different types. In a case where the plurality of pieces of hardware are configured to execute one or a plurality of processes of a certain processor, the plurality of pieces of hardware may exist in devices that are physically separated from each other, or may exist in the same device. The hardware is constituted by an electric circuit (circuitry) or the like in which circuit elements such as a semiconductor device are combined.

In any of the embodiments, an execution order of various processes by the processor is not limited to an order described in each embodiment, and can be changed as necessary. The program may be software such as microcode in addition to firmware. The program may be, for example, a program module group. Each function constituting the program module group may be realized by a processor configured to execute each function. The program in each embodiment may be program codes or a plurality of code segments stored in one or a plurality of non-transitory computer readable media (for example, a semiconductor memory, a magnetic or optical storage medium, or other storages).

The program may be divided and stored in a plurality of non-transitory computer readable media existing in devices that are physically separated from each other. The program code or the plurality of code segments may be represented by any combination of procedures, functions, subprograms, routines, subroutines, modules, software packages, classes, instructions, data structures, and program statements. The program code or the plurality of code segments may be connected to other code segments or hardware circuits by transmitting and receiving information, data, an argument, a parameter, or a memory content.

The memory 12 is a storage area that stores various types of software, data used for execution of the software, and the like, and is used as a work area during arithmetic operation. The memory 12 is constituted by, for example, a random-access memory (RAM).

The storage unit 13 is a storage area that stores input data for various types of software, output data from various types of software, and the like. The storage unit 13 is constituted by, for example, a hard disk drive (HDD), a solid-state drive (SSD), a semiconductor memory, or the like used for storing a program, various pieces of setting data, or the like. The storage unit 13 is provided with a database for storing various types of information. Examples of the database provided in the storage unit 13 include a database in which each of the molding conditions of the injection molding machine 50, the measurement result of the state of the material 200 (refer to FIG. 1), the measurement result of the state of the molding product 210 (refer to FIG. 1), and information on a lot of the material 200 is stored.

The communication unit 14 transmits and receives data between the material camera 30, the injection molding machine 50, the molding product camera 70, the material dryer 90, and the outside via the network 100. The operation unit 15 is constituted by, for example, a keyboard, a mouse, a mechanical button, and a switch, and receives an input operation. The operation unit 15 also includes a touch sensor that constitutes a touch panel integrally with the display unit 16.

The display unit 16 is constituted by, for example, a liquid-crystal display or an organic electroluminescence (EL) display used for displaying information, and displays data such as an image or text. A user interface or the like is displayed on the display unit 16.

### FUNCTIONAL CONFIGURATION OF CONTROL UNIT 11 OF MANAGEMENT SERVER 10

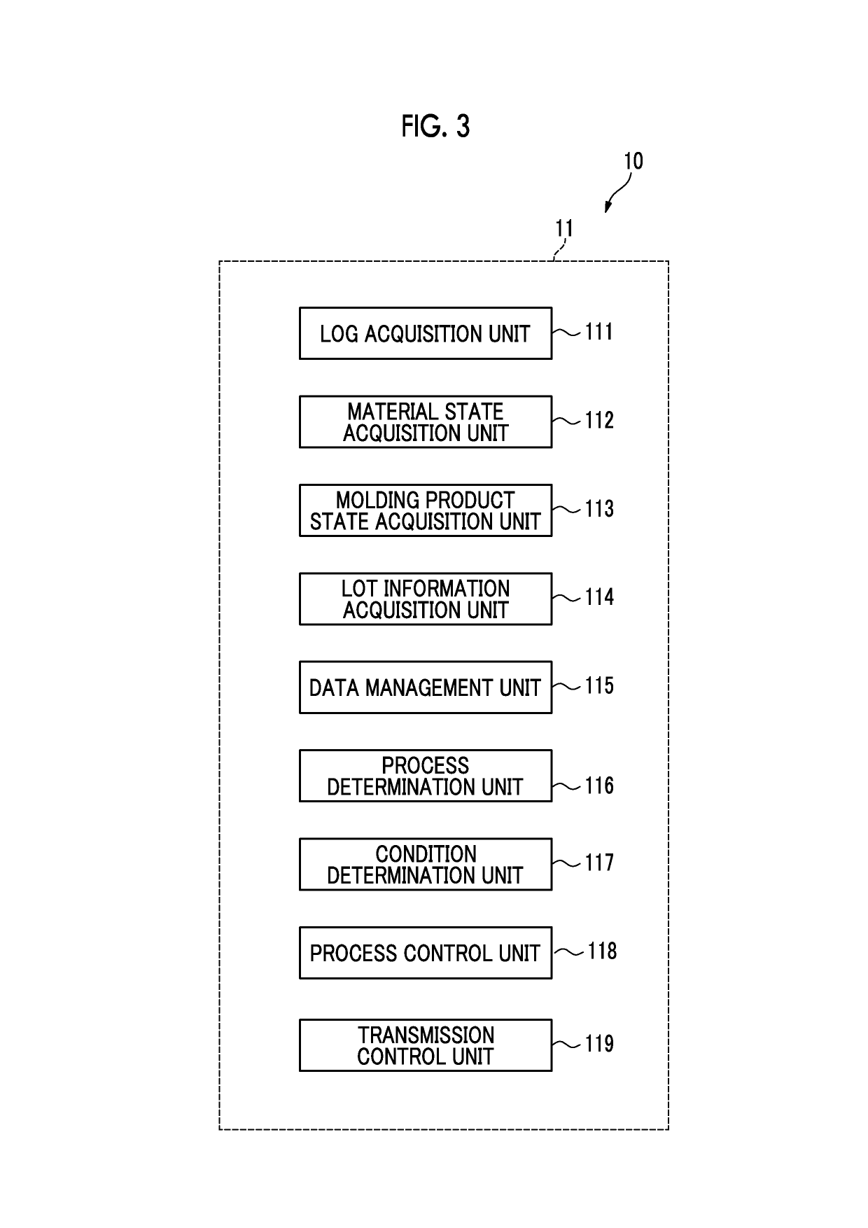

FIG. 3 is a view illustrating an example of a functional configuration of the control unit 11 of the management server 10.

In the control unit 11 of the management server 10, a log acquisition unit 111, a material state acquisition unit 112 serving as material state acquisition means, and a molding product state acquisition unit 113 serving as molding product state acquisition means function. In addition, in the control unit 11, a lot information acquisition unit 114 serving as lot information acquisition means, a data management unit 115, a process determination unit 116, and a condition determination unit 117 function. In addition, the control unit 11 functions as a process control unit 118 serving as process control means and a transmission control unit 119 that performs control to transmit various types of information.

The log acquisition unit 111 acquires log information of the injection molding machine 50 (refer to FIG. 1) including at least the molding conditions of the injection molding machine 50. The log information acquired by the log acquisition unit 111 is stored in a database of the storage unit 13 (refer to FIG. 2). The log information includes waveform data as a measurement result of each of the material camera 30 and the molding product camera 70, a molding history, data relating to the material 200, and the like in addition to the molding conditions. In addition, the log information includes data relating to tree species and a mixture contained in the material 200 (refer to FIG. 1), image data of the molding product 210 (refer to FIG. 1), and the like. Examples of the molding conditions include a filling time, a screw position, a screw speed, an ejector position, an ejector speed, an inflow speed, and a back pressure.

Among the molding conditions, the "filling time" refers to time until the material 200, which is a molten resin injected from the injection unit, is filled in a mold. The "screw position" refers to a position of a screw that rotates and moves forward in a cylinder of the injection unit to feed the material 200 to the outside. The "screw speed" refers to a rotation speed of the screw. The "ejector position" refers to a position of an ejector pin that separates the molding product 210 from the mold in an open state. The "ejector speed" is an operation speed of the ejector pin. The "inflow speed" refers to a speed at which the material 200 flows into the mold. The "back pressure" refers to a pressure that is applied in an injection direction when the material 200 is metered.

The material state acquisition unit 112 acquires information indicating a state of the material 200 before being input to the injection molding machine 50. Specifically, the material state acquisition unit 112 acquires a measurement result of the state of the material 200 as information indicating the state of the material 200. The measurement result of the state of the material 200 includes, for example, the amount of moisture contained in the material 200, the configuration of the material 200, and the degree of deterioration of the material 200. Among these, examples of the configuration of the material 200 include a configuration of a resin and an additive contained in the material 200, a configuration of a plurality of types of resins contained in the material 200, and the like. The measurement result of the state of the material 200 which is acquired by the material state acquisition unit 112 is stored in the database of the storage unit 13.

The molding product state acquisition unit 113 acquires information indicating a state of the molding product 210 after injection molding by the injection molding machine 50. Specifically, the molding product state acquisition unit 113 acquires a measurement result of the state of the molding product 210 as information indicating the state of the molding product 210. For example, the measurement result of the state of the molding product 210 includes a defect (void or silver streak) derived from the amount of moisture contained in the molding product 210, the configuration of the molding product 210, and the like. The measurement result of the state of the acquired molding product 210 is stored in the database of the storage unit 13.

The lot information acquisition unit 114 acquires information on the lot of the material 200. For example, the information on the lot of the material 200 is a lot number that can uniquely specify the material 200 in a predetermined amount (for example, a net amount of the material 200). The acquired information on the lot of the material 200 is stored in the database of the storage unit 13. That is, even in the material 200 manufactured by the same equipment or the same manufacturing method, a slight difference occurs within a range of specifications depending on an environment or the like at the time of manufacturing. For example, when there is a slight difference in water absorptivity of the material 200, there is a slight difference in the amount of moisture of the material 200 between plasticization in which the material 200 is heated and melted and molding in which the melted material 200 is injected into the mold to be molded. As a result, the amount of moisture of the material 200 and the molding conditions may not match each other. However, since the difference is small when the lot at the time of manufacturing is the same, it is preferable to store information on the lot in the database such that feedback can be performed for review of the drying conditions of the material dryer 90 (refer to FIG. 1).

The data management unit 115 stores and manages various data in various databases provided in the storage unit 13. For example, the data management unit 115 stores and manages each of the acquired molding conditions of the injection molding machine 50, the measurement result of the state of the material 200, the measurement result of the state of the molding product 210, and the information on the lot of the material 200 in the database. The data management unit 115 makes it possible to manage the molding conditions of the injection molding machine 50, the measurement result of the state of the material 200, the measurement result of the state of the molding product 210, and information on the lot of the material 200 in association with each other.

The process determination unit 116 determines a molding defect suppression process in correspondence with the measurement result of the state of the material 200 which is acquired by the material state acquisition unit 112. The measurement result of the state of the material 200 is, for example, the amount of moisture of the material 200. The process determination unit 116 determines a process of notifying a worker of the measurement result of the material 200 or a process of reviewing the material 200 itself as the molding defect suppression process. In addition, the process determination unit 116 determines a process of reviewing the drying conditions of the material dryer 90 or a process of reviewing the molding conditions of the injection molding machine 50 as the molding defect suppression process.

Specifically, the process determination unit 116 makes it possible to perform, for example, a process of outputting alert information for warning the worker that the content of the measurement result is at a level that may lead to a molding defect as a process of notifying the worker of the measurement result in the molding defect suppression process. In addition, the process determination unit 116 makes it possible that, for example, the material 200 is returned to the material dryer 90 and is dried again as a process of reviewing the material 200 itself in the molding defect suppression process.

In addition, the process determination unit 116 makes it possible that, for example, the drying conditions of the material dryer 90 are changed as a process of reviewing the drying conditions of the material dryer 90 in the molding defect suppression process. In addition, the process determination unit 116 makes it possible that, for example, the molding conditions of the injection molding machine 50 are changed as a process of reviewing the molding conditions of the injection molding machine 50 in the molding defect suppression process.

In addition, the process determination unit 116 determines the molding defect suppression process in correspondence with the measurement result of the state of the molding product 210 which is acquired by the molding product state acquisition unit 113. For example, the process determination unit 116 determines a process of notifying a worker of the measurement result of the state of the molding product 210 or a process of reviewing the material 200 itself as the molding defect suppression process. In addition, the process determination unit 116 determines a process of reviewing the drying conditions of the material dryer 90 or a process of reviewing the molding conditions of the injection molding machine 50 as the molding defect suppression process.

Specifically, the process determination unit 116 makes it possible to perform the following processes as a process of notifying the worker of the measurement result of the state of the molding product 210 in the molding defect suppression process. That is, the process determination unit 116 makes it possible to perform a process of outputting alert information for notifying the worker of the measurement result of the state of the molding product 210 which indicates occurrence of the molding defect. In addition, the process determination unit 116 makes it possible that the material 200 is returned to the material dryer 90 and dried again as a process of reviewing the material 200 itself in the molding defect suppression process.

In addition, the process determination unit 116 makes it possible that the drying conditions of the material dryer 90 are changed as a process of reviewing the drying conditions of the material dryer 90 in the molding defect suppression process. In addition, the process determination unit 116 makes it possible that the molding conditions of the injection molding machine 50 are changed as a process of reviewing the molding conditions of the injection molding machine 50 in the molding defect suppression process.

The condition determination unit 117 makes it possible to determine the drying conditions and the molding conditions corresponding to the measurement result of the state of the material 200. In addition, the condition determination unit 117 makes it possible to determine the drying conditions and the molding conditions corresponding to the measurement result of the state of the molding product 210. In addition, the condition determination unit 117 makes it possible to determine the drying conditions and the molding conditions corresponding to the measurement result of the state of the material 200 and the measurement result of the state of the molding product 210.

In addition, the condition determination unit 117 makes it possible to determine the drying conditions and the molding conditions based on information on the lot of the material 200. In this case, for example, the condition determination unit 117 makes it possible to determine a temperature in a cylinder of the injection unit of the injection molding machine 50 as the molding conditions based on information on the lot of the material 200.

The process control unit 118 controls the molding defect suppression process determined by the process determination unit 116. For example, the process control unit 118 performs control of a process of notifying the worker of the measurement result of the material 200 or control of a process of notifying the worker of the measurement result of the state of the molding product 210 as control of the molding defect suppression process. In this case, the process control unit 118 performs, for example, control of the process of outputting alert information for warning the worker that the content of the measurement result is at a level that may lead to a molding defect as the control of the process of notifying the worker of the measurement result of the material 200. In addition, the process control unit 118 performs, for example, control of a process of outputting alert information for notifying the worker that the measurement result of the state of the molding product 210 indicates occurrence of a molding defect as the control of the process of notifying a worker of the measurement result of the state of the molding product 210.

In addition, the process control unit 118 performs control of a process of reviewing the material 200 itself as the control of the molding defect suppression process. In this case, the process control unit 118 performs, for example, control of returning the material 200 input to the input port 51 of the injection molding machine 50 to the material dryer 90 and drying the material 200 again as the control of the process of reviewing the material 200 itself. Specifically, the process control unit 118 performs control of returning the material 200 to the material dryer 90 via a pipe connecting the input port 51 of the injection molding machine 50 and the material dryer 90 to each other and drying the material 200 again by the material dryer 90 as the control of returning the material 200 to the material dryer 90 and drying the material 200 again.

More specifically, the process control unit 118 performs control of drying the material 200 again based on the amount of moisture of the material 200 which is acquired as a measurement result of the material 200 by the material state acquisition unit 112 as the control of drying the material 200 again by the material dryer 90. For example, the process control unit 118 outputs control information for drying the material 200 again to the material dryer 90, and outputs an appropriate drying time as the control of drying the material 200 again.

In addition, the process control unit 118 performs control of a process of reviewing the drying conditions of the material dryer 90 or control of a process of reviewing the molding conditions of the injection molding machine 50 as the control of the molding defect suppression process. In this case, the process control unit 118 performs control of updating the drying conditions determined by the condition determination unit 117 to be reflected on the material dryer 90 as the control of the process of reviewing the drying conditions of the material dryer 90. In addition, the process control unit 118 performs control of updating the molding conditions determined by the condition determination unit 117 to be reflected on the injection molding machine 50 as the control of the process of reviewing the molding conditions of the injection molding machine 50.

The transmission control unit 119 performs control for causing the communication unit 14 (refer to FIG. 2) to transmit various types of information to each device constituting the network 100 and to each external device. For example, the transmission control unit 119 causes the determined molding conditions to be transmitted to the injection molding machine 50. In addition, for example, the transmission control unit 119 causes control information for controlling the operation of the material dryer 90 to be transmitted to the material dryer 90.

### FLOW OF PROCESS OF MANAGEMENT SERVER 10

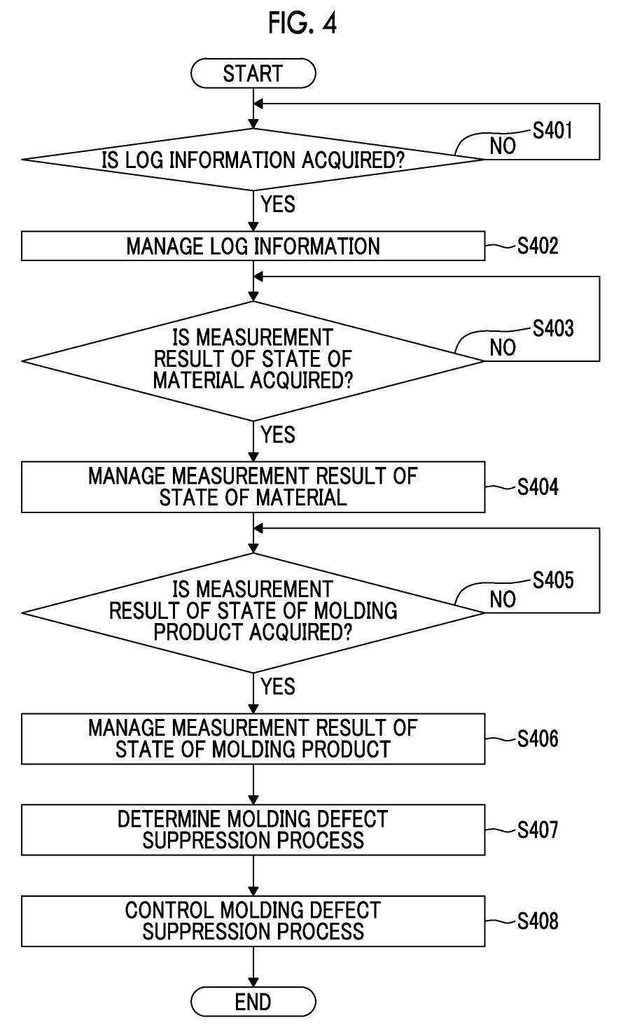

FIG. 4 is a flowchart illustrating an example of a flow of a process of the management server 10. In addition, in FIG. 4, an example of a case where the measurement result of the state of the molding product 210 is acquired is described, but the management server 10 can also determine the molding conditions without acquiring the measurement result of the state of the molding product 210.

When acquiring log information from the injection molding machine 50 (YES in step S401), the management server 10 stores and manages the acquired log information in the database (step S402). On the other hand, in a case where the log information is not acquired (NO in step S401), the management server 10 repeats the determination process in step S401.

When the management server 10 acquires the measurement result of the state of the material 200 (YES in step S403), the management server 10 stores and manages the acquired measurement result of the state of the material 200 in the database (step S404). On the other hand, in a case where the measurement result of the state of the material 200 is not acquired (NO in step S403), the management server 10 repeats the determination process in step S403.

When the management server 10 acquires the measurement result of the state of the molding product 210 (YES in step S405), the management server 10 stores and manages the acquired measurement result of the state of the molding product 210 in the database (step S406). On the other hand, in a case where the measurement result of the state of the molding product 210 is not acquired (NO in step S405), the management server 10 repeats the determination process in step S405.

The management server 10 determines the molding defect suppression process corresponding to the measurement result of the state of the material 200 and the measurement result of the state of the molding product 210 (step S407). Then, the management server 10 controls the determined molding defect suppression process (step S408). In this manner, the process of the management server 10 is terminated (END).

### SPECIFIC EXAMPLE

### SPECIFIC EXAMPLE OF METHOD OF MEASURING STATE OF MATERIAL

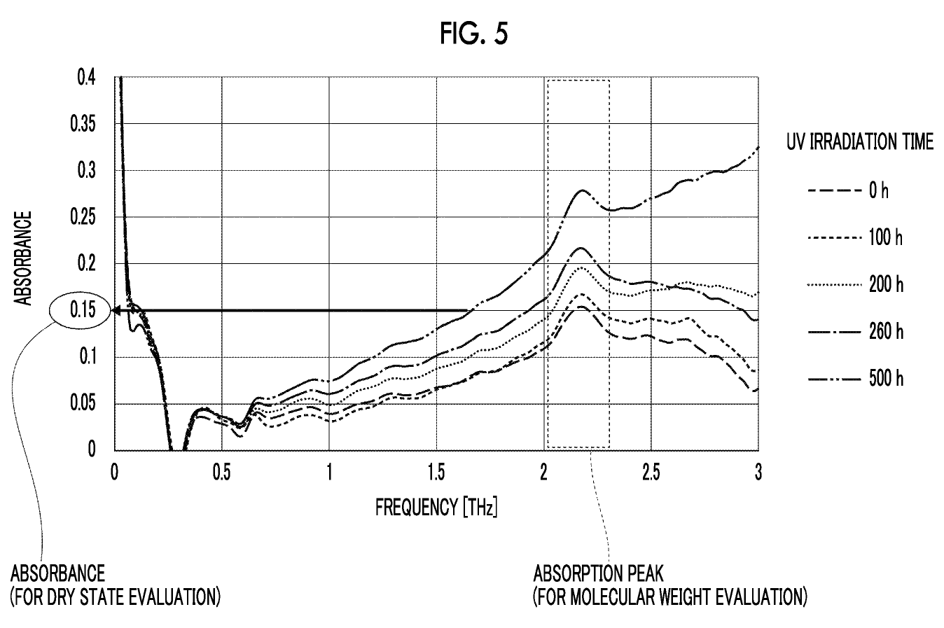

FIG. 5 is a view illustrating a specific example of a method in which the material camera 30 that constitutes the injection molding system 1 in FIG. 1 measures a state of a material by imaging using a millimeter wave or a terahertz wave. FIG. 5 is a graph in which a horizontal axis represents a frequency [THz] and a vertical axis represents absorbance.

For example, the material camera 30 (refer to FIG. 1) makes it possible to measure the amount of moisture contained in the material or to measure a configuration of the material or the degree of deterioration of the material by using the absorbance of electromagnetic waves. In addition, the material camera 30 makes it possible to measure a mixing ratio between a resin, a carbon fiber, and the like constituting the material by comparison with the measurement result of the absorbance of the electromagnetic waves of the resin alone. In this case, as the electromagnetic wave, a millimeter wave having a wavelength of 1 mm to 10 mm and a frequency of 30 GHz to 300 GHz, a terahertz wave having a wavelength of approximately 3 mm to 0.03 mm and a frequency of approximately 100 GHz to 10 THz, or the like is used.

The waveform represented by the graph shown in FIG. 5 is a waveform indicating the absorbance of the terahertz wave of the molding product. From the graph shown in FIG. 5, the absorbance for evaluating a dry state of the material and an absorption peak for evaluating a molecular weight of the material can be read.

The management server 10 (refer to FIG. 1) determines that the material is insufficiently dried in a case where the absorbance of the material is equal to or less than a predetermined threshold (0.15 in the example in FIG. 5). In this case, the management server 10 performs control for operating the material dryer 90 (refer to FIG. 1), such as outputting warning information before the material is input to the injection molding machine 50 (refer to FIG. 1), outputting control information for drying the material again to the material dryer 90, and outputting an appropriate drying time.

In addition, in a case where a material that is insufficiently dried has already been input, the management server 10 determines molding conditions corresponding to the dry state and reflects the molding conditions on the injection molding machine 50. In addition, when the management server 10 confirms in advance that the lot number of the material is switched, the management server 10 determines in advance the molding conditions corresponding to the state of the material after the lot number is switched. Then, the management server 10 reflects the molding conditions on the injection molding machine 50 in accordance with a timing at which the lot number of the material is switched (for example, after n shots (n is an integer of 1 or more)).

In addition, in a case where an absorption peak appears on a low frequency side of a predetermined frequency range (a broken line region in FIG. 5), the management server 10 determines that a molecular weight of the material is too large, and outputs warning information including reviewing of the material. In addition, in a case where the absorption peak appears on a high frequency side of the predetermined frequency range, the management server 10 determines that the molecular weight of the material is too small, and outputs warning information including reviewing of the material.

### SPECIFIC EXAMPLE OF METHOD OF MEASURING STATE OF MOLDING PRODUCT

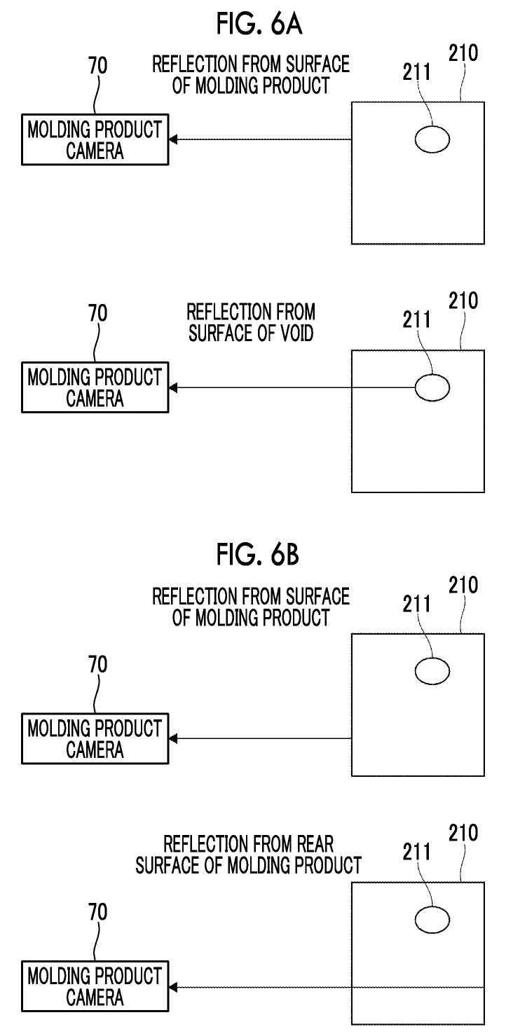

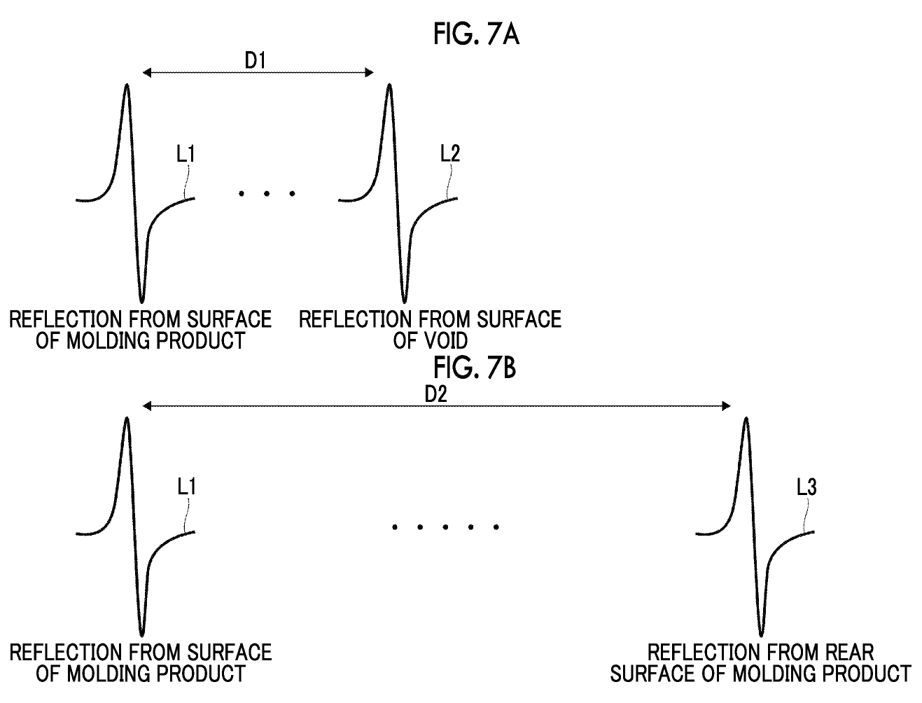

FIGS. 6A and 6B and FIGS. 7A and 7B are views illustrating a specific example of a method in which the molding product camera 70 (refer to FIG. 1) that constitutes the injection molding system 1 in FIG. 1 measures the state of the molding product 210 (refer to FIG. 1) by imaging using a millimeter wave or a terahertz wave.

The molding product camera 70 makes it possible to measure an internal defect of the molding product 210 by using reflection of electromagnetic waves such as millimeter waves and terahertz waves.

FIG. 6A illustrates a specific example in a case where the molding product camera 70 measures a position where a void 211, which is a defect derived from the amount of moisture inside the molding product 210, is formed. FIG. 6B illustrates a specific example in a case where the molding product camera 70 measures a position different from the position where the void 211, which is an internal defect of the molding product 210, is formed.

FIG. 7A illustrates a waveform L1 of reflection of electromagnetic waves from a surface of the molding product 210 (refer to FIGS. 6A and 6B) and a waveform L2 of reflection of electromagnetic waves from a surface of a void 211 (refer to FIGS. 6A and 6B) inside the molding product 210. FIG. 7B illustrates the waveform L1 of reflection of electromagnetic waves from the surface of the molding product 210 and a waveform L3 of reflection of electromagnetic waves from a rear surface of the molding product 210.

As illustrated in FIGS. 6A and 6B, and FIGS. 7A and 7B, there is a time difference between a reflected wave of electromagnetic waves from the surface of the molding product 210, a reflected wave of electromagnetic waves from the surface of the void 211, and a reflected wave of electromagnetic waves from the rear surface of the molding product 210. For example, a time difference D1 occurs between the waveform L1 and the waveform L2 illustrated in FIG. 7A, and a time difference D2 occurs between the waveform L1 and the waveform L3 illustrated in FIG. 7B. By using the time difference of such reflected waves, for example, a tomographic image of the molding product 210 as illustrated in FIGS. 6A and 6B can be generated. Accordingly, it is possible to visualize an internal defect (for example, the void 211) that is not visible in the external appearance of the molding product 210. As a result, not only the state of the material 200 for injection molding, but also the state of the molding product 210 can be reflected on the molding conditions of the injection molding machine 50.

In summary, the injection molding system 1 according to the present embodiment can take various embodiments with the following configuration.

That is, the injection molding system 1 is an injection molding system including the material camera 30 as material imaging means for imaging the material 200 before being input from the material dryer 90 that performs the pre-drying of the material 200 for injection molding to the injection molding machine 50, the process determination unit 116 as material state acquisition means for acquiring a measurement result of a state of the material 200 based on a captured image of the imaged material 200, the process control unit 118 as process control means for controlling one or more processes among a process of giving a notification of the measurement result of the state of the material 200, a process of reviewing the material 200 itself, a process of reviewing drying conditions of the material dryer 90, and a process of reviewing molding conditions of the injection molding machine 50 in correspondence with the acquired measurement result of the state of the material 200.

Accordingly, it is possible to reflect the state of the material 200 which is measured based on the captured image of the material 200 for injection molding on adjustment of the drying conditions of the material dryer 90 or parameters of the molding conditions of the injection molding machine 50. In addition, a worker can be notified of the state of the material 200. In addition, the material 200 that has been sufficiently dried can be used for injection molding. In addition, the state of the material 200 can be reflected on the drying conditions of the material dryer 90, and thus a molding defect can be suppressed. In addition, the state of the material 200 can be reflected on the molding conditions to suppress the molding defect.

In addition, the process control unit 118 may control the process of giving a notification of possibility of causing a molding defect as a process of giving a notification of the measurement result of the state of the material 200.

Accordingly, it is possible to notify the worker of the possibility of causing a molding defect.

In addition, the process control unit 118 may control a process of returning the material 200 to the material dryer 90 and drying the material 200 again as a process of reviewing the material 200 itself.

Accordingly, the material 200 that has been sufficiently dried by the re-drying of the material dryer 90 can be used for injection molding.

In addition, the process control unit 118 may control a process of making a change into drying conditions corresponding to the measurement result of the state of the material 200 as a process of reviewing the drying conditions of the material dryer 90.

Accordingly, the state of the material 200 can be reflected on the drying conditions of the material dryer 90, and a molding defect can be suppressed.

In addition, the process control unit 118 may control a process of making a change into drying conditions further corresponding to the information on the lot of the material 200.

Accordingly, information on the lot of the material 200 for injection molding can be reflected on the drying conditions of the material dryer 90. For example, information indicating that the material 200 is the same type of resin but has a different lot number is stored in the database as information on the lot, and thus the information can be fed back for reviewing of the drying conditions of the material dryer 90. As a result, smooth injection molding can be realized.

In addition, the process control unit 118 may control a process of making a change into molding conditions corresponding to the measurement result of the state of the material 200 as a process of reviewing the molding conditions of the injection molding machine 50.

Accordingly, the state of the molding product 210 can be reflected on the molding conditions of the injection molding machine 50, and a molding defect can be suppressed.

In addition, the process control unit 118 may control a process of making a change into molding conditions further corresponding to the information on the lot of the material 200.

Accordingly, the information on the lot of the material 200 for injection molding can be reflected on the molding conditions. For example, information indicating that the material 200 is the same type of resin but the lot number is different can be reflected on the molding conditions in accordance with a timing at which the lot number is switched (for example, after n shots). As a result, smooth injection molding can be realized.

In addition, the process control unit 118 may control a process of making a change into a cylinder inner temperature as the molding conditions further corresponding to the information on the lot of the material 200.

Accordingly, the information on the lot of the material 200 for injection molding can be reflected on the cylinder inner temperature as the molding condition. For example, the cylinder inner temperature can be changed at a timing at which the lot number is switched (for example, after n shots) in correspondence with each state of the material 200 having the same type of resin but having a different lot number. As a result, smooth injection molding can be realized.

In addition, the material state acquisition unit 112 may acquire the amount of moisture contained in the material 200 as a measurement result of the state of the material 200, and the process control unit 118 may control the process of suppressing a molding defect in accordance with the amount of moisture contained in the material 200.

Accordingly, the amount of the moisture contained in the material 200, which is measured based on the captured image of the material 200 for injection molding, can be reflected on the adjustment of the drying conditions of the material dryer 90 or the parameters of the molding conditions of the injection molding machine 50. In addition, for example, a worker can be notified of the dry state of the material 200, the material 200 itself can be reviewed, the drying conditions of the material dryer 90 can be reviewed, and the molding conditions of the injection molding machine 50 can be reviewed in correspondence with the measured amount of moisture contained in the material 200. As a result, for example, a molding defect caused by the insufficient drying of the material 200 such as voids and silver streaks can be suppressed.

In addition, the material state acquisition unit 112 may acquire information indicating a state of each of the resin and the additive contained in the material 200 as a measurement result of the state of the material 200.

Accordingly, each state of the resin and the additive contained in the material 200 can be reflected on the molding conditions. For example, information such as a mixing ratio between the resin and the additive can be reflected on the molding conditions. As a result, smooth injection molding can be realized.

In addition, the material state acquisition unit 112 may acquire information indicating a mixed state of a plurality of types of resins contained in the material 200 as a measurement result of the state of the material 200.

Accordingly, the mixed state of the plurality of types of resins contained in the material 200 can be reflected on the molding conditions. For example, information such as a mixing ratio of the plurality of types of resins contained in the material 200 can be reflected on the molding conditions. As a result, smooth injection molding can be realized.

In addition, the injection molding system 1 is an injection molding system including the material camera 30 as material imaging means for imaging the material 200 before being input from the material dryer 90 that performs the pre-drying of the material for injection molding to the injection molding machine 50, the material state acquisition unit 112 as material state acquisition means for acquiring a measurement result of a state of the material 200 based on a captured image of the imaged material 200, and the process control unit 118 as process control means for controlling one or more processes among a process of giving a notification of a measurement result of a state of the molding product 210, a process of reviewing the material 200 itself, a process of reviewing drying conditions of the material dryer 90, and a process of reviewing molding conditions of the injection molding machine 50 as a molding defect suppression process in correspondence with the acquired measurement result of the state of the material 200.

Accordingly, it is possible to reflect the state of the material 200 which is measured based on the captured image of the material 200 for injection molding on adjustment of the drying conditions of the material dryer 90 or parameters of the molding conditions of the injection molding machine 50. In addition, the worker can be notified of the state of the molding product 210. In addition, the material 200 that has been sufficiently dried can be used for injection molding. In addition, the state of the molding product 210 can be reflected on the drying conditions of the material dryer 90, and a molding defect can be suppressed. In addition, the state of the molding product 210 can be reflected on the molding conditions to suppress the molding defect.

In addition, the process control unit 118 may control a process of returning the material 200 to the material dryer 90 and drying the material 200 again as a process of reviewing the material 200 itself.

Accordingly, the material 200 that has been sufficiently dried by the re-drying of the material dryer 90 can be used for injection molding.

In addition, the process control unit 118 may control a process of making a change into drying conditions corresponding to the measurement result of the state of the molding product 210 as a process of reviewing the drying conditions of the material dryer 90.

Accordingly, the state of the molding product 210 can be reflected on the drying conditions of the material dryer 90, and a molding defect can be suppressed.

In addition, the process control unit 118 may control a process of making a change into drying conditions further corresponding to the information on the lot of the material 200.

Accordingly, information on the lot of the material 200 for injection molding can be reflected on the drying conditions of the material dryer 90. For example, information indicating that the material 200 is the same type of resin but has a different lot number is stored in the database as information on the lot, and thus the information can be fed back for reviewing of the drying conditions of the material dryer 90. As a result, smooth injection molding can be realized.

In addition, the management server 10 as a control device according to the present embodiment can take various embodiments with the following configuration.

That is, the management server 10 is a control device including the material camera 30 as material imaging means for imaging a state of the material 200 before the material 200 is input from the material dryer 90 that performs the pre-drying of the material 200 for injection molding to the injection molding machine 50, the material state acquisition unit 112 as material state acquisition means for acquiring a measurement result of a state of the material 200 based on a captured image of the imaged material 200, a process control unit 118 that controls one or more processes among a process of giving a notification of the measurement result of the state of the material 200, a process of reviewing the material 200 itself, a process of reviewing drying conditions of the material dryer 90, and a process of reviewing molding conditions of the injection molding machine 50 in correspondence with the acquired measurement result of the state of the material 200.

In addition, an injection molding method according to the present embodiment can take various embodiments with the following configuration.

That is, the injection molding method by the injection molding system 1 includes a step of imaging the material 200 before being input from the material dryer 90 that performs the pre-drying of the material 200 for injection molding to the injection molding machine 50, a step of acquiring a measurement result of a state of the material 200 based on a captured image of the imaged material 200, a step of controlling one or more processes among a process of giving a notification of the measurement result of the state of the material 200, a process of reviewing the material 200 itself, a process of reviewing drying conditions of the material dryer 90, and a process of reviewing molding conditions of the injection molding machine 50 in correspondence with the acquired measurement result of the state of the material 200.

In addition, a non-transitory computer readable medium storing a program according to the present embodiment can take various embodiments with the following configuration.

That is, the non-transitory computer readable medium storing the program applied to the injection molding system 1 is the non-transitory computer readable medium storing the program when executed by a processor, causing the processor to control one or more processes among a process of imaging the material 200 before being input to the injection molding machine 50 from the material dryer 90 that performs pre-drying of the material 200 for injection molding, a process of acquiring a measurement result of a state of the material 200 based on a captured image of the imaged material 200, a process of giving a notification of the measurement result of the state of the material 200, a process of reviewing the material 200 itself, a process of reviewing the drying conditions of the material dryer 90, and a process of reviewing the molding conditions of the injection molding machine 50 in correspondence with the acquired measurement result of the state of the material 200.

In addition, the injection molding system 1 is an injection molding system including the material camera 30 as material imaging means for imaging the material 200 before being input from the material dryer 90 that performs the pre-drying of the material 200 for injection molding to the injection molding machine 50, the material state acquisition unit 112 as material state acquisition means for acquiring a measurement result of a state of the material 200 based on a captured image of the imaged material 200, and the process control unit 118 as process control means for controlling a process of suppressing a molding defect in correspondence with the acquired measurement result of the state of the material 200.

Accordingly, it is possible to reflect the state of the material 200 which is measured based on the captured image of the material 200 for injection molding on adjustment of the drying conditions of the material dryer 90 or parameters of the molding conditions of the injection molding machine 50. In addition, for example, a worker can be notified of the measurement result or the material 200 itself can be reviewed in correspondence with the measured state of the material 200. As a result, it is possible to suppress a molding defect.

In addition, the injection molding system 1 according to the present embodiment can take various embodiments with the following configuration.

That is, the injection molding system 1 is an injection molding system including the molding product camera 70 as molding product imaging means for imaging the molding product 210 after injection molding, the molding product state acquisition unit 113 as molding product state acquisition means for acquiring a measurement result of a state of the molding product 210 based on a captured image of the imaged molding product 210, and the process control unit 118 as process control means for controlling a molding defect suppression process for suppressing a molding defect in correspondence with the acquired measurement result of the state of the molding product 210.

In this manner, it is possible to reflect the state of the molding product 210 which is measured based on the captured image of the molding product 210 on adjustment of the drying conditions of the material dryer 90 or the parameters of the molding conditions of the injection molding machine 50. In addition, for example, a worker can be notified of the measurement result or the material 200 itself can be reviewed in correspondence with the measured state of the molding product 210. As a result, it is possible to suppress a molding defect. Specifically, for example, by acquiring a change or a difference in the appearance of the molding product 210 which is caused by the amount of moisture of the material 200 as information indicating the state of the molding product 210 from the captured image of the molding product 210, occurrence of silver streaks that have become apparent on a surface of the molding product 210 can be detected. Then, this information can be fed back into the drying conditions of the material 200.

It should be understood that the invention is not limited to the above-described embodiment, but may be modified into various forms on the basis of the spirit of the invention. Additionally, the modifications are included in the scope of the invention.

What is claimed is:

1. An injection molding system comprising:
a material imaging unit that images a material before being input from a material dryer that performs pre-drying of the material for injection molding to an injection molding machine;
a material state acquisition unit that acquires a measurement result of a state of the material based on a captured image of the imaged material; and
a process control unit that controls one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

2. The injection molding system according to claim 1,
wherein the process control unit controls a process of giving a notification of a possibility of causing a molding defect as the process of giving a notification of the measurement result of the state of the material.

3. The injection molding system according to claim 1,
wherein the process control unit controls a process of returning the material to the material dryer to dry the material again as the process of reviewing the material itself.

4. The injection molding system according to claim 1,
wherein the process control unit controls a process of making a change into a drying condition corresponding to the measurement result of the state of the material as the process of reviewing the drying condition.

5. The injection molding system according to claim 4,
wherein the process control unit controls a process of making a change into a drying condition further corresponding to information on a lot of the material.

6. The injection molding system according to claim 1,
wherein the process control unit controls a process of making a change into a molding condition corresponding to the measurement result of the state of the material as the process of reviewing the molding condition.

7. The injection molding system according to claim 6,
wherein the process control unit controls a process of making a change into a molding condition corresponding to information on a lot of the material.

8. The injection molding system according to claim 7,
wherein the process control unit controls a process of making a change into a cylinder inner temperature as the molding condition further corresponding to the information on the lot of the material.

9. The injection molding system according to claim 1,
wherein the material state acquisition unit acquires an amount of moisture contained in the material as the measurement result of the state of the material, and
the process control unit controls a process for suppressing a molding defect in correspondence with the amount of moisture.

10. The injection molding system according to claim 1,
wherein the material state acquisition unit acquires information indicating each of states of a resin and an additive contained in the material as the measurement result of the state of the material.

11. The injection molding system according to claim 1,
wherein the material state acquisition unit acquires information indicating a mixed state of a plurality of types of resins contained in the material as the measurement result of the state of the material.

12. An injection molding system comprising:
a material imaging unit that images a material before being input from a material dryer that performs pre-drying of the material for injection molding to an injection molding machine;
a material state acquisition unit that acquires a measurement result of a state of the material based on a captured image of the imaged material; and
a process control unit that controls one or more processes among a process of giving a notification of a measurement result of a state of a molding product, a process of reviewing the material itself for injection molding, a process of reviewing a drying condition of the material dryer, and a process of reviewing a molding condition of the injection molding machine in correspondence with the acquired measurement result of the state of the material.

13. The injection molding system according to claim 12,
wherein the process control unit controls a process of returning the material to the material dryer to dry the material again as the process of reviewing the material itself.

14. The injection molding system according to claim 12,
wherein the process control unit controls a process of making a change into a drying condition corresponding to the measurement result of the state of the molding product as the process of reviewing the drying condition.

15. The injection molding system according to claim 14,
wherein the process control unit controls a process of making a change into the drying condition further corresponding to information on a lot of the material.

16. A control device comprising:
a material imaging unit that images a material before being input from a material dryer that performs pre-drying of the material for injection molding to an injection molding machine;
a material state acquisition unit that acquires a measurement result of a state of the material based on a captured image of the imaged material; and
a process control unit that controls one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

17. An injection molding method comprising:
a step of imaging a material before being input from a material dryer that performs pre-drying of the material for injection molding to an injection molding machine;
a step of acquiring a measurement result of a state of the material based on a captured image of the imaged material; and
a step of controlling one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

18. A non-transitory computer readable medium storing a program when executed by a processor, causing the processor to:
image a material before being input from a material dryer that performs pre-drying of the material for injection molding to an injection molding machine;
acquire a measurement result of a state of the material based on a captured image of the imaged material; and
control one or more processes among a process of giving a notification of the measurement result of the state of the material, a process of reviewing the material itself, a process of reviewing a drying condition of the material dryer, and a process of reviewing a molding condition of the injection molding machine in correspondence with the acquired measurement result of the state of the material.

19. An injection molding system comprising:
a material imaging unit that images a material before being input from a material dryer that performs pre-drying of a material for injection molding to an injection molding machine;
a material state acquisition unit that acquires a measurement result of a state of the material based on a captured image of the imaged material; and
a process control unit that controls a process for suppressing a molding defect in correspondence with the acquired measurement result of the state of the material.

20. An injection molding system comprising:
a molding product imaging unit that images a molding product after injection molding;
a molding product state acquisition unit that acquires a measurement result of a state of the molding product based on a captured image of the imaged molding product; and
a process control unit that controls a process for suppressing a molding defect in correspondence with the acquired measurement result of the state of the molding product.
